(19) United States
(12) Patent Application Publication
(10) Pub. No.: US 2025/0216017 A1
(43) Pub. Date: Jul. 3, 2025

(54) PROTECTOR FOR TUBULAR THREADED ELEMENTS

(71) Applicant: VALLOUREC OIL AND GAS FRANCE, Aulnoye-Aymeries (FR)

(72) Inventors: Guillaume BERTHET, Meudon (FR); Gerardo Manuel MAGALLANES MONTALVO, Meudon (FR); Maxime VANNETZEL, Meudon (FR)

(73) Assignee: VALLOUREC OIL AND GAS FRANCE, Aulnoye-Aymeries (FR)

(21) Appl. No.: 18/845,741

(22) PCT Filed: Apr. 11, 2023
(86) PCT No.: PCT/EP2023/059440

§ 371 Date: Sep. 10, 2024

(30) Foreign Application Priority Data
Apr. 15, 2022 (FR) 2203557

(51) Int. Cl. F16L 58/18; E21B 17/042

(52) U.S. Cl. CPC F16L 58/182; E21B 17/042

(57) ABSTRACT

A protector is for a tubular threaded element for drilling, exploitation of hydrocarbon wells, transport of oil and gas, transport or storage of hydrogen, carbon capture or geothermy. The protector includes a main body that includes at least one exterior axial surface extending axially and facing outward in such a manner as to be able in the assembled state to face the interior surface wall of a tubular threaded element. The exterior axial surface of the main body is fitted with at least one seal adapted in the assembled state to block particles of scale.

### TECHNICAL FIELD

The invention concerns tubular threaded elements and more precisely protectors for protecting the end of those elements, such as a protector for a tubular threaded element for drilling or exploitation of hydrocarbon wells, transport of oil and gas, transport or storage of hydrogen, carbon capture or geothermy.

### TECHNOLOGICAL BACKGROUND

Here, by “tubular element” is meant any element or accessory used for drilling or exploitation of a well and having at least one threaded end, also known as a connection or connector, and intended to be assembled by a thread to another tubular element to constitute with that other element a tubular threaded joint. The tubular element may be a tubular threaded element. The tubular threaded element may be of relatively great length (in particular approximately around ten metres in length), for example a tube, or a tubular sleeve a few tens of centimetres long, or an accessory for those tubular threaded elements (suspension device or “hanger”, change of section part or “cross-over”, safety valve, a drilling rod connector or “tool joint”, “sub”, and the like).

The tubular elements are generally assembled to one another to be lowered into hydrocarbon wells or similar wells and to constitute a drill column, a lining tube column (casing), a casing column (lining) or a production tube column (tubing) (exploitation column).

The specification API 5CT issued by the American Oil Institute (API), equivalent to the standard ISO 11960 issued by the International Standardisation Organisation (ISO), governs the tubes used as casings or linings and the specification API 5B defines standard threads for those tubes.

API specification 7 defines shouldered threaded connections for rotary drill pipes.

The tubular threaded elements most usually include one or more substantially trapezoidal threads which have an engagement flank (also known as a stabbing flank) on the side of the threads directed towards the free end of the threaded elements concerned, a loading flank on the side opposite the engagement threads, a thread crest of non-zero width and a thread root also of non-zero width.

The aforementioned tubular threaded elements may have a male threaded end that is intended to be screwed into a female threaded end of another drilling or exploitation tubular element. It is therefore essential that their male and female ends be damaged as little as possible, polluted as little as possible and degraded as little as possible between the time at which they leave the production line and that at which they are used and also between two successive uses. It will be understood that it is in fact necessary to protect against corrosion, dust and impacts (or blows) not only the thread but also any bearing and abutment surface or surfaces which have specific and complementary functions, in particular in order to produce a seal in phases of use.

So-called premium or semi-premium tubular threaded elements generally have at least one abutment surface. A first abutment surface of a first tubular threaded element may be brought into contact with a second abutment surface of a second tubular threaded element to form an abutment when screwing them together. An abutment surface may consist of the transverse annular surface of a free end part of a male or female end of a tubular threaded element.

Furthermore, the ends of the aforementioned elements may be coated with a grease having an anti-binding property just before they are assembled together.

However, it is more and more common to replace this grease with a combination of surface treatments and coatings having anti-corrosion and/or anti-binding properties applied in thin layers to the functional surfaces of a tubular threaded element. One or more functional surfaces may be one or more threads, one or more bearing surfaces, one or more abutments.

For example, a seal comprising superposed layers comprising anti-corrosion zinc-nickel and an anti-binding layer of lubricating polymer of polyurethane type is known from the document EP 3286288.

Protectors are devices the function of which is to protect the aforementioned functional surfaces of the tubular threaded elements and any coatings on said functional surfaces. A protector has a substantially cylindrical general shape and generally comprises a body and a fastening means. The solution generally adopted for fastening a protector onto a tubular threaded element is to screw it onto the connection thread. This solution enables a simple mounting gesture associated with precise positioning.

The protector may include a thread adapted to be screwed onto or into the thread of a male or female tubular threaded element. The thread may be of the same type as and have the same pitch as that of the connection. A protector thread may comprise stabbing flanks on the side of the thread oriented toward the free end of the protector, said stabbing flanks being intended to come into contact with stabbing flanks of the threads of a tubular threaded element when screwing the protector onto the connection. Said protector thread may also have loading flanks, thread crests and roots and at least one abutment surface.

An abutment surface of a protector is generally radial and may be configured to be brought into contact with the abutment surface of a tubular threaded element.

The main aim of a protector is to protect a functional surface against various types of external attack: mechanical damage such as mechanical impacts, pollution (chemical or material) such as dust deposited on the functional surfaces, or corrosion of the materials between the time at which the tubular element leaves the production line and that at which it is used (possibly with multiple mounting-demounting of the protection device). A protector is also intended to protect a coating to protect said functional surface from external attack.

Protectors have been provided with sealing means to strengthen the seal of the spaces comprising the functional surfaces with or without a coating or coatings of a connection against moisture, a flow of water caused by condensation or a flow of air. These sealing means are generally mounted on the protector and are made with shapes and of materials conferring on them increased flexibility compared to the very rigid body of the protector in order for a portion of their surface to come into contact with a surface of the connection in order to produce a sealed contact.

However, the applicant has noted that during arrival on storage sites of a tubular threaded element provided with a known prior art protector a problem of abrasion at the level of the top layer of the coating has been observed on multiple tubes with a frequency of occurrence of the fault that can be as high as 75% of said tubes. Thus the applicant has noted a degraded top coating, for example the layer that confers the anti-binding properties, which may consist of a layer of polymer such as a layer of polyurethane (PU) and/or of the thread with no coating despite the use of a prior art protector.

The applicant has discovered that the source of this abrasion problem is linked to the presence of solid particles inside the tubular threaded element at the level of the functional surfaces.

The solid particles may have diverse origins and may consist of scale formed during heat treatment of the steel of the tube, corundum consisting of particles of aluminium oxide used for surface preparation during the application of a treatment such as that described in the patent EP 3286288 or particles of rust formed inside the tubes during periods of storage outdoors. It may also consist of shot and/or of sand used in descaling/cleaning the inside of the tubes. More rarely it may consist of metal swarf resulting from the production of the thread of a tubular threaded element. Generally speaking these solid particles therefore originate from the tubular threaded element itself (FIG. 1).

There is known for example the prior art document U.S. Pat. No. 7,284,770 which describes a protector including two seals mounted on the body of the protector, made of different materials, for example elastomers, and producing a seal at two distinct locations. A first seal to produce an internal seal at the level of the distal end of the tubular element, that is to say at the level of an abutment surface, and a second seal to produce an external seal on an external wall upstream of the thread of the tubular element.

On the one hand, a seal to produce an external seal is located upstream of the thread and cannot provide a barrier to solid particles such as scale originating from the interior of a tubular threaded element without said solid particles or scale first arriving on the functional surface and degrading it. This type of seal therefore cannot protect the thread from being degraded and is therefore not suitable. On the other hand, a seal designed to produce a seal at the distal end, that is to say at the level of the abutment surface of a tubular threaded element, is not satisfactory and allows infiltration of solid particles such as scale. In fact, the applicant has discovered that the more fragile elastomer material of the seal and high mechanical stresses at the level of the abutment surfaces, that is to say vibrations and impacts between tubes weighing several tons, contribute to creating movement and small gaps at the level of said seal. Said gaps can allow solid particles such as scale to pass and therefore have the effect of loss of the protection and sealing function.

Another problem has been identified with this type of seal, namely that it also tends to remain stuck to the abutment surface of the tubular threaded element when removing the protector, the end user having systematically to carry out an additional visual inspection to verify that no seal remains stuck on and to remove it if necessary.

Moreover, experience has shown us that without external intervention during movement of the tubes at the factory or during transportation the protectors become unscrewed extremely frequently. In fact, as the tubes are round during phases of bundling and unbundling the protectors, the outside diameter of which is greater than that of the tubes or tubular threaded elements, they are going to come into contact with one another and depending on the direction of the tubes this frequently causes loosening of the protector. In the event of temperature variations, the thermal expansion is not the same for a metal tubular threaded element as for a plastic protector, the consequence of which is to accentuate loosening of the protector.

Furthermore, the seal providing the external seal comes into contact with the surface of the connection as soon as installation of the protector begins and the friction forces of these seals are very high because of their more flexible material. Consequently the operations of screwing on and of unscrewing these protectors employing this type of seal necessitate more force and more time.

Other solutions developed by the applicant have used protectors comprising only an external seal because infiltration of water is greater via the exterior of the tube in the event of rain or of passage through a washing machine on the packaging line, compared to lesser internal infiltration resulting mainly from phenomena of condensation on the internal wall of the tube on storage sites. However, this solution does not address either the problem stemming from solid particles originating from the inside of the tube such as scale or corundum and is essentially concentrated on the seal against water to improve anti-corrosion performance.

It has been established by the applicant that a seal of a protector configured to come into contact with an abutment surface of a tubular threaded element or with the external face of a tubular threaded element or at the level of the distal ends, in particular upstream of the thread along a longitudinal axis, or against a seal placed in the annulus of the protector, is not suitable for blocking solid particles such as scale inside the tube.

The invention makes it possible to solve all of the aforementioned problems. In particular the invention proposes a solution consisting of a male or female protector including a seal for blocking solid particles inside the tube originating from a tubular threaded element and in particular scale particles.

In accordance with one embodiment the invention provides a protector for a tubular threaded element for drilling, exploitation of hydrocarbon wells, transport of oil and gas, transport or storage of hydrogen, carbon capture or geothermy, said protector including a main body, where said main body may include at least one exterior axial surface extending axially and facing outward in such a manner as to be able in the assembled state to face an internal wall of a tubular threaded element, characterized in that the exterior axial surface of said main body may be fitted with at least one seal adapted in the assembled state to block particles of scale.

By exterior axial surface is meant a cylindrical or frustoconical surface of the protector extending along a longitudinal axis Z and having a generatrix. This exterior axial surface does not include an abutment surface or form part of an abutment surface of a protector. The exterior axial surface may however adjoin an abutment surface of a protector.

By provided with at least one seal is meant provided with a seal that is either mounted directly on top of the exterior axial surface or that said surface allows a local discontinuity in the form of a cavity or a housing to accommodate the seal. A seal may include a base part that comes into contact with said axial surface or said housing.

Thanks to this feature, when the protector is screwed onto the tubular threaded element the position of the seal is such that it rests on the internal wall of the tubular threaded element. This makes it possible to block the circulation of any solid particles and in particular of scale from the interior of the tubular threaded element toward the functional surface of said tubular threaded element and in particular the bearing surface and the thread.

Thanks to this feature, when mounted on a tubular threaded element the protector in accordance with the invention enables protection of a functional surface or of a polymer type coating of said tubular threaded element from being degraded. In particular, the protector enables effective protection against a coating containing polyurethane (PU) and therefore the anti-binding properties of the coating being degraded.

Thanks to this feature, the position of the seal is such that said seal is freed of the problem of loosening of the protector caused by movement of the tubes in the factory, during transportation and/or in the event of temperature variations.

Thanks to this feature, the seal in accordance with the invention greatly enhances the brake effect of the protector. The brake effect of the protector refers to the capacity of a protector not to be unscrewed when subjected to external stresses, that is to say mechanical and/or thermal stresses encountered during the lifecycle of the tubular threaded element. In fact, during screwing it on the protector will store anti-unscrewing energy thanks to a supplementary torque applied by the seal inside the tube in addition to that produced by the threaded protector. In the absence of a seal in accordance with the invention there are more conventional brake effects that rely only on the torque imposed by the protector abutting on the threaded part and/or a torque generated in the threads that is/are completely ineffective as soon as the protector is even slightly loosened.

Thanks to this feature, the seal in accordance with the invention is also freed of the problem of a seal for producing a sealed surface at the level of an abutment surface that remains stuck on after removal of the protector. There is therefore no need to carry out visual inspection to be sure whether the seal is still stuck on or not and therefore precious time is saved if there is taken into consideration for example the extremely costly daily hire of an oil platform.

In accordance with one embodiment the main body may include at least one exterior radial surface and at least one interior radial surface, said interior radial surface extending radially and opposite said exterior radial surface along a longitudinal axis Z.

In accordance with one embodiment the protector is characterized in that it may further include a thread having a thread pitch P and an abutment surface configured to be brought into contact with a corresponding abutment surface of said tubular threaded element.

In accordance with one embodiment, the protector is characterized in that the exterior axial surface includes a housing configured to accommodate the seal.

Thanks to this feature, a housing enables attachment of a seal and anchoring it in the main body of the protector. The entire seal or part of the seal, in particular the base part of the seal, may be attached in this way.

In accordance with one embodiment, the protector is characterized in that the exterior axial surface further includes a seal support, said seal support including said housing.

In accordance with one embodiment, the seal support may be formed integrally with the main body.

In accordance with one embodiment, the seal support may be a completely separate part and connected to or mounted on the main body of the protector.

Thanks to this feature, the seal support facilitates assembly of the seal onto to main body.

Thanks to this feature, the seal support facilitates assembling the seal onto said main body. In fact, the seal support achieves this facilitation compared to certain types of protector that structurally prevent an operative sliding their hands to insert the seal.

Thanks to this feature, the seal support therefore makes it possible to remove the seal more easily to recycle the protector by providing it with a new seal, in particular, when it is necessary to change the seal in the event of excessive wear of said seal.

Thanks to this feature, a seal support enables cleaning of the protector to remove solid particles by simpler removal of the seal support. This removal enables

In accordance with one embodiment, the protector is characterized in that said housing containing the seal may include at least one profiled section configured to retain said seal in the housing.

A profiled section may be various shapes and may for example be a segment or a protuberance that extends axially from the exterior axial surface or extends it. A profiled section may also be a protuberance that extends axially from a housing support including a housing.

Thanks to this feature, the profiled section will enable improved retention of said seal in said housing and therefore prevent escape or sliding of the seal.

In accordance with one embodiment, the protector is characterized in that said seal is of elastomer, flexible bristle brush, foam or plastic lip type.

Thanks to this feature, each of these types of seal exercises its barrier function when it interferes with the internal wall of the tube to block solid particles and in particular scale. Furthermore, because of the more flexible material an elastomer type seal has improved capabilities of adaptation and of elastic deformation in the housing of a seal support. A seal of the type with flexible brush bristles or foam has a low cost of manufacture and is very easy to install. A plastic lip type seal has the advantage of a small number of manufacturing steps.

In accordance with one embodiment, the protector is characterized in that the support is connected to the exterior axial surface by means of a reverse screw pitch system optionally reinforced with glue, a riveting system, a friction welding system or a welding system that adds material.

Thanks to this feature, the seal support is stronger and prevents the risk of detachment when faced with storage or transport conditions and impacts caused by the production line and loading or offloading phases. The glue enables additional strengthening of the assembly.

In accordance with one embodiment, the protector is characterized in that the minimum position of the seal relative to the axis Z is determined by the following equation:

$$Zp 2 \geq P / 2$$

with:
P: value in mm of the thread pitch of the protector.
Zp2: value in mm of the distance along the axis Z between the abutment surface of the protector and the seal.

Thanks to this feature, a minimum position is established in order for the seal against solid particles to be preserved if the protector is slightly loosened and the protector has not moved back along the axis Z a distance greater than Zp2 with P/2 being a minimum safety distance corresponding to half the value in mm of the pitch of the thread of the protector.

Similarly, the minimum position also makes it possible to preserve the brake effect if the protector is slightly loosened and the protector has not moved back along the axis Z a distance greater than Zp2. This provides an additional safety feature in that the protector will remain correctly in place on the threaded part of the tubular threaded element.

Thanks to this feature, the minimum position of the seal makes it possible to be sure that the seal is sufficiently far away from any abutment surface, that is to say from the abutment surface of the protector or the abutment surface of the tubular threaded element, when in the assembled state. This minimum distance enables protection of the seal from the junction of the abutment surfaces of the tubular threaded element and of the protector, where impacts can be violent.

In the situation where the pitches of the protector are not constant, for example P1 followed by P2 with P1 different from P2, then P always corresponds to the smallest value.

Zp2 necessarily implies a non-zero distance of the seal relative to the abutment, that is to say a distance greater than 0.

In accordance with one embodiment, the protector is characterized in that the maximum position of the seal relative to the axis Z may be determined by the following equation:

$$Zp 2 + Zp 1 \leq Zf$$

with:
Zf: value of the distance between the abutment surface and the end of the male or female thread of the protector along the axis Z.
Zp1: value of the axial contact length of the seal at the level of the exterior axial surface along the axis Z.
Zp2: value in mm of the distance along the axis Z between the abutment surface of the protector and the seal.

Thanks to this feature, it is sure that the brake effect conferred by the seal does not begin too soon, that is to say before engagement of the threads of the protector with those of the tubular threaded element. In fact, in this situation great force and more time will be needed to install it. Additionally, too great a brake effect can also make manual unscrewing difficult or even impossible, obliging an operative to use dedicated tools to loosen the protector, thus generating additional operating costs and a considerable waste of time.

In accordance with one embodiment, the protector is characterized in that the maximum position of the seal relative to the axis Z is between, inclusive:

$$0.05 \times ( Zf ) \leq Zp 2 + Zp 1 \leq 0.3 \times ( Zf )$$

with:
Zf: value of the distance between the abutment surface and the end of the male or female thread of the protector along the axis Z.
Zp1: value of the axial contact length of the seal at the level of the exterior axial surface along the axis Z.
Zp2: value in mm of the distance along the axis Z between the abutment surface of the protector and the seal.

Thanks to this feature, an optimum position of the seal is assured with the best ratio between the level of conservation of the seal in the event of loosening of the protector and the level of the brake effect.

Finally, another object of the present application is a tubular threaded element including a protector in accordance with any of the embodiments of the invention described above.

### BRIEF DESCRIPTION OF THE FIGURES

The invention will be better understood and other aims, details, features and advantages thereof will become more clearly apparent in the course of the following description of particular embodiments of the invention given by way of non-limiting illustration only and with reference to the appended drawings.

FIG. 1 depicts in schematic longitudinal section a prior art protector in contact with a tubular threaded element.

FIG. 2 depicts in schematic longitudinal section a male protector in accordance with a first embodiment of the invention fitted with a seal.

FIG. 3 depicts in schematic longitudinal section a male protector in accordance with a second embodiment of the invention fitted with a seal.

FIG. 4 depicts in schematic longitudinal section a portion of a female protector in accordance with a third embodiment of the invention fitted with a seal support formed integrally with the main body including a seal.

FIG. 5 depicts in schematic longitudinal section a male protector in accordance with a fourth embodiment of the invention in the state mounted on a tubular threaded element.

FIG. 6 depicts in schematic longitudinal section a male protector including a seal in accordance with a fifth embodiment of the invention.

FIG. 7 depicts in schematic longitudinal section a portion of a male protector in accordance with a sixth embodiment of the invention including a seal support with at least one profiled section.

FIG. 8 depicts in schematic longitudinal section a portion of a male protector in accordance with a seventh embodiment of the invention including an exterior axial surface with at least one profiled section.

### DETAILED DESCRIPTION OF THE FIGURES

In the remainder of the description and the claims the terms “exterior” and “interior” and the orientations “axial” and “radial” will be used to designate, in accordance with the definitions given in the description, elements of a protector or of a tubular threaded element. The longitudinal axis Z determines the “axial” orientation. The “radial” orientation is orthogonal to the longitudinal axis Z.

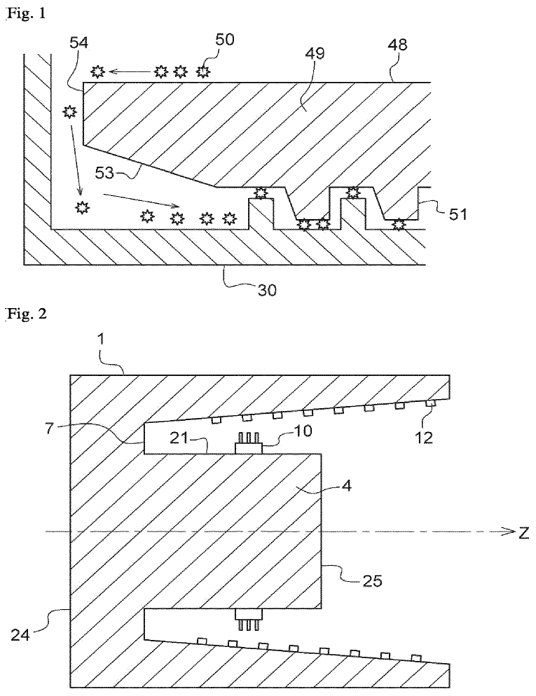

FIG. 1 depicts a prior art male protector 30 assembled with a male tubular threaded element 49 comprising an internal wall 48, a thread 51, a bearing surface 53 and an abutment surface 54.

To be more specific, FIG. 1 shows the paths of solid particles such as scale or corundom from inside the tubular threaded element 49, for example from the internal wall 48, and infiltrating at the level of the thread 51 by passing over the abutment surface 54 and the surface of the protector 30. The presence of said solid particles can damage the thread 51 or for example an anti-binding top layer of a coating applied to said thread 51 and is liable to lead to possible rejection of the tubular threaded element 49 when it arrives on the production or drilling site. Absence of any seal or incorrect positioning of the seal, such as a seal on the abutment surface 54 or upstream of the thread 51 to produce an external seal, leads to the same unsatisfactory result.

FIG. 2 depicts a male protector 1 in accordance with one embodiment of the invention including a male thread 12 and an abutment surface 7. Said male thread 12 is configured to be screwed onto the opposite male thread of a male tubular element 49. Said abutment surface 7 is configured to be brought into contact with the abutment surface at one end of a male tubular threaded element 49. The protector 1 also includes a main body 4 including at least one exterior radial surface 24 and at least one interior radial surface 25. The radial surfaces both extend radially and are opposite one another along a longitudinal axis Z. Said main body 4 has an exterior axial surface 21 for which in this embodiment no discontinuity is allowed. An exterior axial surface 21 begins at the abutment surface 7 and terminates at the interior radial surface 25. Said exterior axial surface does not include the thread of the protector.

By exterior axial surface is meant a cylindrical or frustoconical surface of the protector extending along a longitudinal axis Z and having a generatrix. The exterior axial surface 21 faces outward in such a manner as to be located inside a tubular threaded element and facing an internal wall of said tubular threaded element when the male or female protector is mounted on said male or female tubular threaded element.

Said exterior axial surface 21 bears a seal 10 adapted in the assembled state to block solid particles 50 such as scale. The seal 10 is mounted on the axial surface and is not part of the main body 4, that is to say is not formed integrally with the main body 4.

The seal 10 may be of elastomer, flexible bristle brush, foam or plastic lip type. These types of seal may have different additional advantages but are all at least capable of blocking solid particles such as scale or corundom.

Because of the more flexible material an elastomer type seal has improved elastic deformation and adaptation capabilities in the housing of a seal support. A foam or flexible bristle brush type seal is cheap to manufacture and very easy to install. A plastic lip type seal has the advantage of a small number of manufacturing steps.

The seal 10 being mounted on the exterior axial surface 21, the latter is configured to be brought into contact with the internal wall of a tubular threaded element during screwing of the protector onto said tubular threaded element.

The position of the seal 10 frees said seal from the problem of loosening of the protector because of movement of the tubes in the factory, during transportation and/or in the event of temperature variations. In particular this position enables said seal to remain sufficiently far away from high stress zones such as the abutment surface. In the assembled state this makes a complete seal possible without creating gaps and movement responsible for potential infiltration of solid particles into the zone of the functional surfaces of a tubular threaded element. Another advantage of the position of the seal 10 is that it makes it possible to improve the brake effect of the protector.

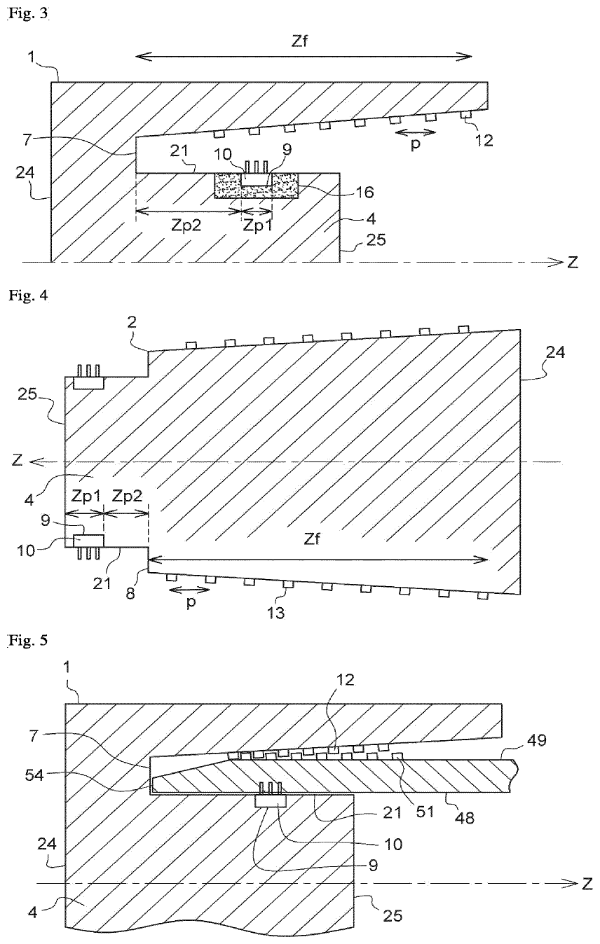

FIG. 3 depicts a portion of a male protector 1 in accordance with the invention. This second embodiment differs from that in FIG. 2 in that said main body 4 has an exterior axial surface 21 including a discontinuity in the form of a housing 9. The main body 4 includes a seal support 16. The seal support may be made of a different material to the main body 4 and be mounted on or formed integrally with said main body 4. However, the invention is not restricted to this embodiment and may encompass other variants in which the seal support is formed integrally with said main body 4.

In FIG. 3 the thread pitch P is the value in mm of the thread pitch of the protector 1. The thread pitch concept must be understood in the light of the standard ISO 5408:2009 which discusses the definition of threads. However, it will be noted that the male or female thread concept differs for the protectors compared to the tubular threaded elements. In fact, a male or female protector is qualified not in relation to the orientation of the thread but rather to their correspondence with the male or female tubular threaded element. For example, a protector is a male protector if it is intended to be screwed onto and to protect a male tubular threaded element. For example, the protector is a female protector if it is intended to be screwed into and to protect a female tubular threaded element.

Zf is the value of the distance along the axis Z between the abutment surface 7 and the end of the male thread 12 of the protector 1. Then, Zp1 is the value of the axial contact length of the seal 10 at the level of the exterior axial surface 21 along the axis Z. Finally, Zp2 is the value in mm of the distance along the axis Z between the abutment surface 7 of the protector 1 and the seal 10.

On the one hand, the minimum position of the seal 10 relative to the axis Z is determined by the following equation:

$$Zp 2 \geq P / 2$$

with:
P: value in mm of the thread pitch of the protector.
Zp2: value in mm of the distance along the axis Z between the abutment surface of the protector and the seal.

This minimum position makes it possible to preserve the benefit of the brake effect if the protector is slightly loosened and has not moved back along the axis Z a distance greater than Zp2 where P/2 is a minimum safety distance equal to half the value in mm of the thread pitch P of the protector. This is a safety measure that ensures that the protector remains correctly in place on the threaded part of the tube.

On the other hand, the maximum position of the seal 10 relative to the axis Z is determined by the following equation:

$$Zp 2 + Zp 1 \leq Zf$$

with:
Zf: value of the distance between the abutment surface and the end of the male or female thread of the protector along the axis Z.
Zp1: value of the axial contact length of the seal at the level of the exterior axial surface along the axis Z.

Zp2: value in mm of the distance along the axis Z between the abutment surface of the protector and the seal.

Thanks to this feature, it is sure that the brake effect conferred by the seal 10 is not too high. The objective is to facilitate manual unscrewing by an operative without using an unscrewing tool in order to save time to facilitate use of the invention.

In accordance with one embodiment, the maximum position of the seal relative to the axis Z is between, inclusive:

$$0.05 \times ( Zf ) \leq Zp 2 + Zp 1 \leq 0.3 \times ( Zf )$$

with:
Zf: value of the distance between the abutment surface and the end of the male or female thread of the protector along the axis Z.
Zp1: value of the axial contact length of the seal at the level of the exterior axial surface along the axis Z.
Zp2: value in mm of the distance along the axis Z between the abutment surface of the protector and the seal.

This makes it possible to ensure an optimum position of the seal to obtain the best ratio between a sufficient brake effect and sufficient protection of the seal in use.

All of the equations remain valid with or without a seal support and for a male protector 1 or a female protector 2.

For simplicity, examples of empirical values of the parameters of the equations have been determined and validated for all of the equations described above. Those values are set out in table 1 below for male protectors according to the nominal outside diameter (OD) of the protector:

TABLE 1

| | | | |
|---|---|---|---|
| OD (mm) | 208.275 | 154.3 | 284.475 |
| Zp2 (mm) | 6 | 6 | 8 |
| Zp1 (mm) | 6 | 6 | 6 |
| P (mm) | 8.5 | 5.1 | 5.1 |
| Zf (mm) | 140 | 125 | 145 |

All the developments described for a male protector are applicable to a female protector.

FIG. 4 depicts a female protector 2 in accordance with one embodiment of the invention. The female protector 2 includes a female thread 13 configured to be screwed to the opposite female thread of a female tubular threaded element (not represented in FIG. 4) and an abutment surface 8 configured to be brought into contact with an abutment surface of a female tubular threaded element. The protector 2 also includes a main body 4 including at least one exterior radial surface 24 and at least one interior radial surface 25 extending radially and opposite one another along a longitudinal axis Z of said exterior radial surface.

Said main body 4 includes an exterior axial surface 21 which in this embodiment allows a discontinuity in the form of a housing 9 forming part of the exterior axial surface 21. There is no seal support in this figure but the female protector may equally well include a seal support 16 including said housing 9.

In FIG. 4 the thread pitch P is the value in mm of the thread pitch of the protector. Zf is the value of the distance along the axis Z between the abutment surface 8 and the end of the female thread 13 of the protector 2. Then, Zp1 corresponds to the value of the axial contact length of the seal 10 at the level of the exterior axial surface 21 along the axis |Z. Finally, Zp2 is the value in mm of the distance along the axis Z between the abutment surface 8 of the protector 2 and the seal 10.

For simplicity, examples of empirical values of the parameters of the equations have been determined and validated for all of the equations described above. Those values are set out in table 2 below for female protectors according to the nominal outside diameter (OD) of the protector:

TABLE 2

| | | | |
|---|---|---|---|
| OD (mm) | 208.275 | 154.3 | 284.475 |
| Zp2 (mm) | 4 | 3 | 3 |
| Zp1 (mm) | 6 | 6 | 6 |
| P (mm) | 8.5 | 5.1 | 5.1 |
| Zf (mm) | 99 | 91 | 136 |

The equations developed in FIG. 3 for a male protector are applicable to a female protector.

Generally speaking and by analogy, all of the developments established for a female protector in accordance with the invention are applicable to a male protector and vice versa.

FIG. 5 depicts a male protector 1 in accordance with one embodiment of the invention when assembled with a tubular threaded element 49. In this configuration the abutment surface of the protector 7 and the abutment surface 54 of the tubular threaded element are in contact. The threads 12 of the protector 1 and of the tubular threaded element 51 are engaged. The exterior axial surface 21 faces the internal wall 48 of the tubular threaded element 49.

In this embodiment said exterior axial surface 21 includes a discontinuity in the form of a housing 9 including a seal 10 but the invention may equally well include an exterior axial surface 21 with no housing 9 but provided with the seal 10.

In the assembled state the seal 10 is in contact with the internal wall 48 to block solid particles and in particular scale. Said seal 10 may be of elastomer, flexible bristle brush, foam or plastic lip type.

In this configuration the position of the seal 10 is clear as well as its ability to block solid particles originating from the wall 48 so that they do not damage the functional surfaces, for example the bearing surface 53 and the thread 51.

In the assembled state the interior radial surface 25 is located inside the tubular threaded element. The exterior radial surface 24 is opposite said interior surface 25 and need not be located inside the tubular threaded element.

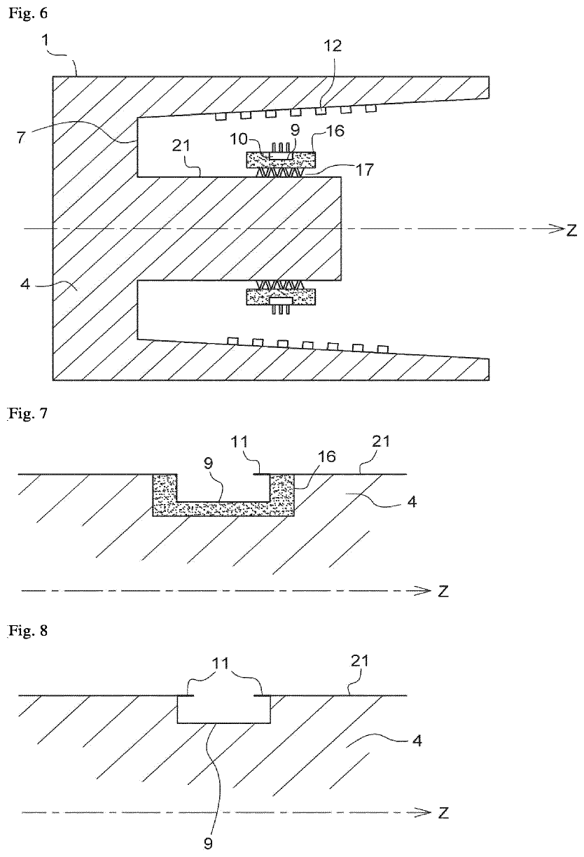

FIG. 6 depicts a male protector 1 including an abutment surface 7, a thread 12, a main body 4 and an exterior axial surface 21. Said exterior axial surface 21 includes a seal support 16 that is not formed integrally with the main body 4 and said seal support includes a housing 9.

The seal support 16 including the housing 9 is connected to the exterior axial surface 21 by means of a reversed screw pitch system 17 or by means of a riveting system, friction welding means or welding means that add material. Each of these connecting means may optionally be reinforced with glue.

This means that the seal support can be stronger and avoids the risk of the seal support 16 becoming detached during storage and transportation and in the event of impacts caused by the production line and the loading or offloading phase. When present, the glue enables additional reinforcement of the assembly comprising the seal support 16, the housing 9 and the seal 10.

As represented in FIG. 7 the housing 9 may have a profiled section 11 at the level of the housing 9.

The exterior axial surface 21 in FIG. 6 is continuous in this embodiment but the invention encompasses the situation in which the exterior axial surface 21 may also be discontinuous.

FIG. 7 depicts an embodiment of the invention in which the exterior axial surface 21 of the male or female protector includes a local discontinuity in which a seal support 16 including a housing 9 has been mounted.

In this embodiment the material of the seal support is different from that of the main body 4 and the seal support includes a housing 9 to accommodate a seal 10. Said housing 9 has a profiled section 11 that extends along an axis Z and is configured to cover a seal partly in order to retain said seal 10 in the housing 9.

A profiled section may take various forms and may for example be a segment or a protuberance extending axially from the exterior axial surface or extending the latter. A profiled section may equally be a protuberance that extends axially from a seal support including a housing.

FIG. 8 depicts a variant of the invention in which the exterior axial surface 21 of a male or female protector including a housing 9 includes at least one profiled section 11.

Either of the profiled sections 11 extends along axis Z and projects axially from the exterior axial surface 21. The protuberant segment is configured to cover a seal 10 partly or to cover at least the base part of a seal 10 in order to retain said seal 10 in the housing 9.

1-11. (canceled)

12. A protector for a tubular threaded element for drilling, exploitation of hydrocarbon wells, transport of oil and gas, transport or storage of hydrogen, carbon capture or geothermy, said protector comprising:
a main body, said main body including at least one exterior axial surface extending axially and facing outward in such a manner as to be able in the assembled state to face an internal wall of a tubular threaded element,
wherein the exterior axial surface of said main body is fitted with at least one seal configured in the assembled state to block particles of scale.

13. The protector according to claim 12, wherein said seal is of an elastomer, a flexible bristle brush, a foam, or a plastic lip type.

14. The protector according to claim 12, wherein the exterior axial surface includes a housing configured to accommodate the seal.

15. The protector according to claim 14, wherein the exterior axial surface further includes a seal support, said seal support including said housing.

16. The protector according to claim 14, wherein said housing containing the seal includes at least one profiled section configured to retain said seal in the housing.

17. The protector according to claim 15, wherein the support is connected to the exterior axial surface by a reverse screw pitch system, a riveting system, a friction welding system, or a welding system that adds material.

18. The protector according to claim 17, wherein the reverse screw pitch system is reinforced with glue.

19. The protector according to claim 12, further comprising a thread having a thread pitch P and an abutment surface configured to be brought into contact with a corresponding abutment surface of said tubular threaded element.

20. The protector according to claim 19, wherein a minimum position of the seal relative to a axis Z is determined by the following equation:
$$Zp 2 \geq P / 2$$
with:
P: value in mm of the thread pitch of the protector; and
Zp2: value in mm of a distance along the axis Z between the abutment surface of the protector and the seal.

21. The protector according to claim 19, wherein a maximum position of the seal relative to a axis Z is determined by the following equation:
$$Zp 2 + Zp 1 \leq Zf$$
with:
Zf: value of a distance between the abutment surface and an end of the male or female thread of the protector along the axis Z;
Zp1: value of the axial contact length of the seal at the level of the exterior axial surface along the axis Z; and
Zp2: value in mm of a distance along the axis Z between the abutment surface of the protector and the seal.

22. The protector according to claim 21, wherein the maximum position of the seal relative to the axis Z is between, inclusive:
$$0.05 \times ( Zf ) \leq Zp 2 + Zp 1 \leq 0.3 \times ( Zf )$$
with:
Zf: value of the distance between the abutment surface and the end of the male or female thread of the protector along the axis Z;
Zp1: value of the axial contact length of the seal at the level of the exterior axial surface along the axis Z; and
Zp2: value in mm of the distance along the axis Z between the abutment surface of the protector and the seal.

23. A tubular threaded element comprising:
the protector acccording to claim 12.
